(19) United States
(12) Patent Application Publication
(10) Pub. No.: US 2026/0304500 A1
(43) Pub. Date: Oct. 1, 2026

(54) PROTOCOL RELAY DEVICE, PROTOCOL RELAY SYSTEM, PROTOCOL RELAY METHOD, AND PROTOCOL RELAY PROGRAM

(71) Applicant: Nippon Telegraph and Telephone Corporation, Tokyo (JP)

(72) Inventors: Takeshi Yamada, Musashino-shi, Tokyo (JP); Kenta Shinohara, Musashino-shi, Tokyo (JP)

(21) Appl. No.: 18/992,651

(22) PCT Filed: Jul. 27, 2022
(86) PCT No.: PCT/JP2022/028895

§ 371 Date: Jan. 9, 2025

(51) Int. Cl. H04W 76/10; H04L 61/2514; H04W 76/30

(52) U.S. Cl. CPC H04W 76/10; H04L 61/2514; H04W 76/30

(57) ABSTRACT

A protocol relay device (100) includes a C-plane processing unit (10), a U-plane processing unit (20), and a UPF container management unit (30). The UPF container management unit (30) notifies a UPF pod (300) of connection establishment. The C-plane processing unit (10) determines a UPF pod (300) for performing transmission processing of a PDU session which is designated in a request packet, and notifies the UPF pod (300) of a determination result. The U-plane processing unit (20) identifies a session ID of user plane traffic received from a base station (202), and transmits the user plane traffic to the corresponding UPF pod (300) based on the determination result.

### TECHNICAL FIELD

The present invention relates to a protocol relay device, a protocol relay system, a protocol relay method, and a protocol relay program.

### BACKGROUND ART

In recent years, a 5th generation core network (5GC) has been provided. The 5GC is a mobile core network system including 5G radio. On the other hand, in a core network (evolved packet core (EPC)) of a 4th generation core network (4GC) in the related art, specifications of an interface between devices are determined in a point-to-point manner, and functions of a control plane and a user plane are not separated.

Meanwhile, in the 5GC, functions of the control plane and the user plane are clearly separated (this is also called control and user plane separation (CUPS)). By using C/U separation, functions of the control plane and the user plane can be independently developed. Thereby, in the 5GC, a service based architecture (SBA) is introduced for processing of the control plane.

In the 5GC, as a service based architecture is introduced, a service mesh is incorporated, and a micro service architecture can be configured by containerization in a device related to the control plane.

In the service based architecture, communication is performed via a service mesh such as istio using hyper text transfer protocol (HTTP) or the like. On the other hand, in an N4 interface between a session management unit and a user plane function (UPF), a protocol called a packet transmission control protocol (RFCP) is used. Further, in an N3 interface between a user plane device and a base station (next generation node B (gNB)), a protocol called a GPRS tunneling protocol for user plane (GTP-U) is used.

Here, for example, free 5gc that is 5GC open source software discloses that a user plane device can be configured by a container (Non Patent Literature 1).

In addition, in free5gc, in each protocol of RFCP and GTP-U, it is necessary to expose a unique Internet protocol (IP) address of the own device to the opposing device. For this reason, in each protocol of RFCP and GTP-U, it is necessary to assign an Internet protocol (IP) address to each containerized user plane device.

Further, for example, Multus is disclosed as a technique of assigning an IP address to each user plane device to perform communication with an external device (Non Patent Literature 2).

### CITATION LIST

### Non Patent Literature

Non Patent Literature 1:“free5gc”, [online], GitHub Inc., [Retrieved on Jul. 7, 2022], the Internet <https://github.com/abousselmi/docker-free5gc>

Non Patent Literature 2:“Multus”, [online], GitHub Inc., [Retrieved on Jul. 7, 2022], the Internet <https://github. com/k8snetworkplumbingwg/multus-cni>

### SUMMARY OF INVENTION

### Technical Problem

In a case where a unique IP address is assigned to a containerized user plane device and communication is performed, there is a problem that it is difficult to perform flexible operation. For example, in a case where a unique IP address is assigned to each container and communication is performed, it is necessary to change a setting for each device in an operation scene where scale-out or scale-in of a container is required, and it is difficult to flexibly operate a container such as dynamic scale-out or dynamic scale-in.

The present invention has been made in view of the above points, and an object of the present invention is to provide a protocol relay device, a protocol relay system, a protocol relay method, and a protocol relay program capable of flexibly operating a containerized user plane device.

### Solution to Problem

According to the present invention, there is provided a protocol relay device connected to one or two or more user plane functions (UPFs), the protocol relay device including: a UPF container management unit that receives a connection request from the UPF, stores an IP address according to an interface of a connection request source, and notifies the UPF of connection establishment; a control plane processing unit that determines, in a case where a packet-transmission-control-protocol request packet is received, a UPF for performing transmission processing of a protocol data unit (PDU) session which is designated in the request packet, and notifies the UPF of a determination result; and a user plane processing unit that identifies a session identification (ID) of user plane traffic received from a base station, executes network address translation on the user plane traffic based on the determination result, and transmits the user plane traffic to the corresponding UPF.

### Advantageous Effects of Invention

According to the present invention, it is possible to flexibly operate a containerized user plane device by the protocol relay device, the protocol relay system, the protocol relay method, and the protocol relay program.

### BRIEF DESCRIPTION OF DRAWINGS

FIG. 1 is a block diagram illustrating an overall configuration of a protocol relay system according to the present embodiment.

FIG. 2 is a block diagram illustrating an overall configuration of the protocol relay system for explaining a concealment scheme from a base station.

FIG. 3 is a block diagram illustrating configurations of a protocol relay device and UPF pods in the protocol relay system according to the present embodiment.

FIG. 4 is a flowchart illustrating an overall flow in a case where the protocol relay device of the protocol relay system executes concealment processing of the UPF pod.

FIG. 5 is a flowchart illustrating a flow in a case where the protocol relay device of the protocol relay system executes connection establishment with the UPF pod.

FIG. 6 is a flowchart illustrating a flow in a case where the protocol relay device of the protocol relay system executes communication with a session management unit.

FIG. 7 is a flowchart illustrating a flow in a case where the protocol relay device of the protocol relay system executes transmission by U-plane processing.

FIG. 8 is a flowchart illustrating a flow in a case where the protocol relay device of the protocol relay system executes disconnection of the UPF pod.

FIG. 9 is a hardware configuration diagram illustrating an example of a computer that implements functions of the protocol relay device.

FIG. 10 is a block diagram illustrating a 5GC system architecture.

FIG. 11A is an explanatory diagram illustrating an environment before update in Blue/Green update.

FIG. 11B is an explanatory diagram illustrating an environment after update in Blue/Green update.

FIG. 12A is an explanatory diagram illustrating a state before a UPF container is concealed.

FIG. 12B is an explanatory diagram illustrating a state after a UPF container is concealed.

### DESCRIPTION OF EMBODIMENTS

Next, an embodiment for carrying out the present invention (hereinafter, referred to as the “present embodiment”) will be described. First, an outline of the present technique will be described using the related art as a comparative example. The same reference numerals are given to the same members and configurations, and description thereof will be omitted as appropriate.

### Outline of Present Technique

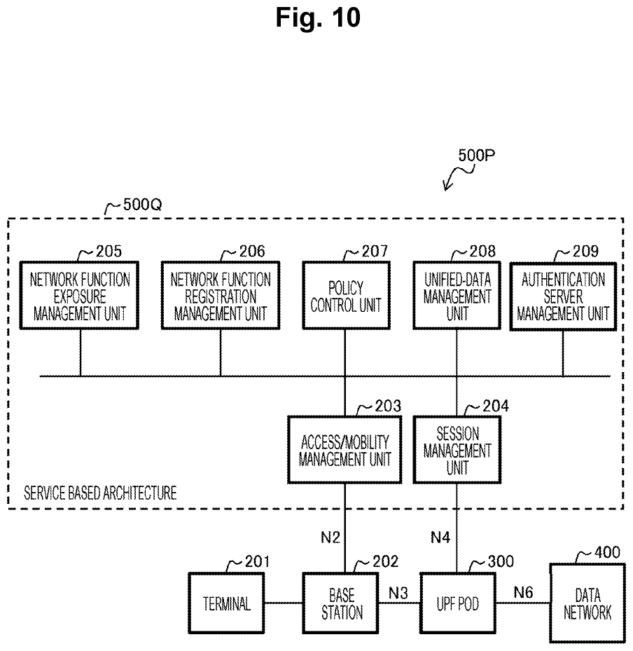

FIG. 10 is a block diagram illustrating a 5GC system architecture. As illustrated in FIG. 10, a 5GC system architecture 500P includes a terminal 201, a base station 202, an access/mobility management unit 203, a session management unit 204, a network function exposure management unit 205, a network function registration management unit 206, a policy control unit 207, a unified-data management unit 208, an authentication server management unit 209, a UPF pod 300, and a data network 400. Note that “/” is used to mean “and.”

The terminal 201 indicates a wireless terminal (user equipment, UE).

The base station 202 indicates a wireless base station (next generation Node B (gNB)) compatible with a 5G wireless system.

The access/mobility management unit 203 has a function of managing access and mobility (an access and mobility management function (AMF)).

The session management unit 204 has a function of managing a session (a session management function (SMF)).

The network function exposure management unit 205 functions as a centralized point for exposing services (a network exposure function (NEF)), and indicates a role of approving all connection requests transmitted from the outside of the system.

The network function registration management unit 206 indicates a function of registering network functions and services generated by the network functions (a network repository function (NRF)).

The policy control unit 207 indicates a function of controlling policies and rules of the 5G system (a policy control function (PCF)).

The unified-data management unit 208 indicates a function of managing many services related to users and subscriptions (unified data management (UDM)).

The authentication server management unit 209 indicates a function of processing a procedure related to authentication (an authentication server function (AUSF)).

The UPF pod 300 indicates a function of transmitting a user data packet (a user plane function (UPF)). The data network 400 is a generic term for a network (data network (DN)) to which a server that provides the Internet or some services is connected.

Note that, although only one UPF pod 300 is illustrated, a plurality of UPF pods 300 are connected to each other to configure a network. Further, the UPF pod 300 is an example of a UPF, and the UPF can be realized by, for example, a container, a virtual machine, a server, or the like. Note that the UPF pod 300 is illustrated as a minimum unit of a UPF container.

In addition, a service-based architecture 500Q is implemented by the access/mobility management unit 203, the session management unit 204, the network function exposure management unit 205, the network function registration management unit 206, the policy control unit 207, the unified-data management unit 208, and the authentication server management unit 209.

In the present technique, a comparative example when updating the UPF container will be described. There are a reversible scheme and an irreversible scheme for updating the UPF container under new and old environments, and a reversible scheme is often required in a business firm that operates a public communication network such as 5G.

For example, Blue/Green update is a reversible scheme. In a state where two environments of a new environment and an old environment are prepared, it is possible to perform switching to the new environment and then perform back-switching to the old environment. On the other hand, a rolling update scheme is an irreversible scheme in which back-switching to the old environment cannot be performed since the old environment is open while the environment of the container is sequentially shifted to the new environment.

In the Blue/Green update of the UPF container, a U-plane traffic path is rerouted from a Blue environment to a Green environment. Therefore, in the Blue/Green update of the UPF container, a connection of the U-plane traffic established between the terminal 201 and the UPF pod 300 in the Blue environment is disconnected, and communication from the terminal 201 is temporarily unusable.

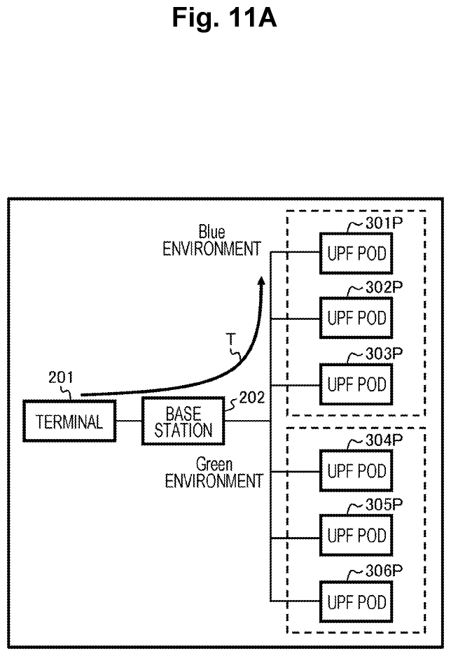

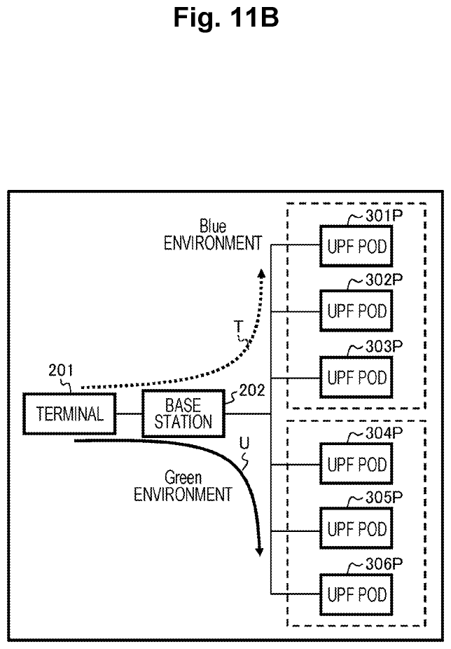

FIG. 11A is an explanatory diagram illustrating an environment before update in the Blue/Green update, and FIG. 11B is an explanatory diagram illustrating an environment after update in the Blue/Green update.

As illustrated in FIG. 11A, a path T of the U-plane traffic before update is directed to the Blue environment. In addition, the UPF pods 301P to 303P are to be used in the Blue environment, and the UPF pods 304P to 306P are to be used in the Green environment.

As illustrated in FIG. 11B, after the update, the path T of the U-plane traffic transmitted by the UPF pods 301P to 303P in the Blue environment is disconnected by the update, and a path U of the new U-plane traffic generated after the update is transmitted and processed in the Green environment.

In this case, in a case where the configurations of the UPF containers in the Blue environment and the Green environment can be concealed, it is possible to avoid an effect of disconnecting the path T of the U-plane traffic.

### Consideration of Concealment

In order to flexibly operate a UPF container, it is considered to conceal a configuration of the UPF container.

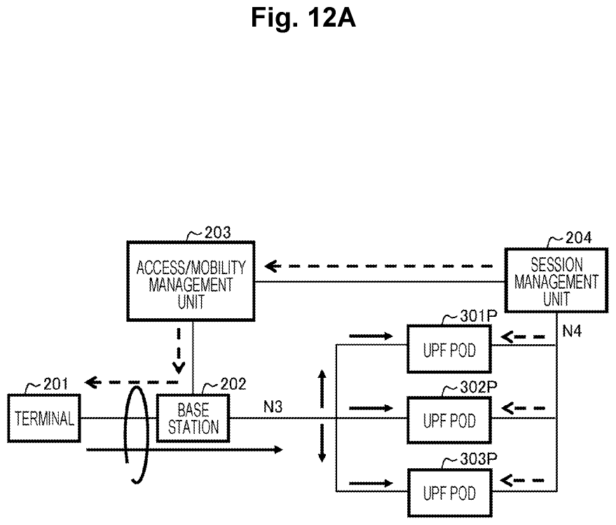

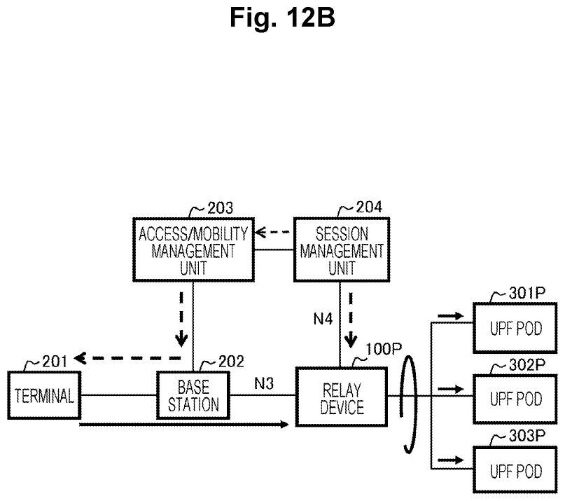

FIG. 12A is an explanatory diagram illustrating a state before concealing the UPF container, while FIG. 12B is an explanatory diagram illustrating a state after concealing the UPF container.

In order to conceal the configuration of the UPF container (the UPF pods 301P to 303P), it is considered to provide a gateway called a relay device 100P between the UPF pods 301P to 303P and the session management unit 204 (refer to FIG. 12B). In this case, the session management unit 204 performs communication with an IP address of the relay device 100P, and the UPF pods 301P to 303P are recognized as one device.

The session management unit 204 has a function of notifying the terminal 201 of the IP addresses of the UPF pods 301P to 303P for C-plane processing in addition to the communication with the UPF pods 301P to 303P. Therefore, in a case where the UPF pods 301P to 303P are concealed as illustrated in FIG. 12B, a single IP address is notified to the terminal 201.

In this case, the relay device 100P needs to appropriately distribute the PDU session for each of the UPF pods 301P to 303P in the U-plane communication processed between the terminal 201 and the UPF pods 301P to 303P (refer to solid arrows in FIG. 12B).

Here, the GTP-U of the N3 interface and the FRCP of the N4 interface do not adopt a scheme such as a service-based architecture (a common Kubernetes communication scheme). Therefore, in a case of concealing the UPF container, it is necessary to simultaneously conceal both the N3 interface and the N4 interface.

Therefore, a protocol relay device according to the present embodiment can flexibly operate the containerized UPF by appropriately concealing the configuration of the UPF container.

### Outline of Concealment in Protocol Relay System

### 1. Concealment of UPF Pod From Session Management Unit

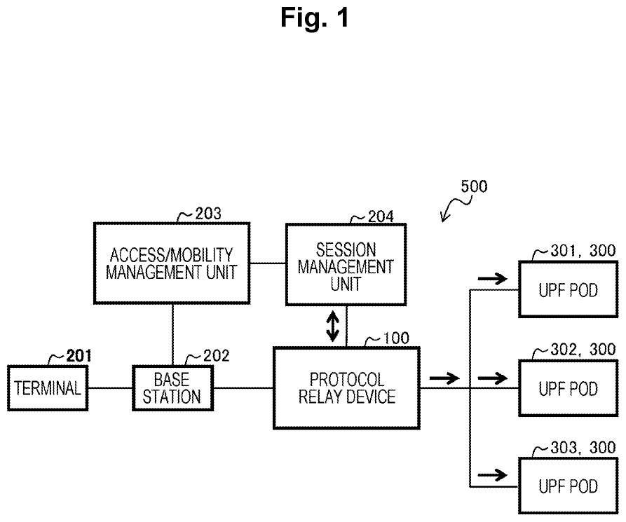

FIG. 1 is a block diagram illustrating an overall configuration of a protocol relay system according to the present embodiment. Note that FIG. 1 illustrates a scheme of concealing the UPF pods 300 to 303 from the session management unit 204.

As illustrated in FIG. 1, a protocol relay system 500 includes a terminal 201, a base station 202, an access/mobility management unit 203, a session management unit 204, a protocol relay device 100, and UPF pods 301 to 303. The UPF pods 301 to 303 are simply referred to as UPF pods 300 in a case where it is not necessary to limit the UPF pod to any one.

The protocol relay device 100 terminates PFCP communication by executing C-plane processing with the session management unit 204. In addition, the protocol relay device 100 executes C-plane adjustment for the UPF pods 301 to 303, and notifies each of the UPF pods 301 to 303 of an adjustment result. Note that the C-plane adjustment means determining the UPF pod 300 for the PDU session.

### 2. Concealment of UPF Pod From Base Station

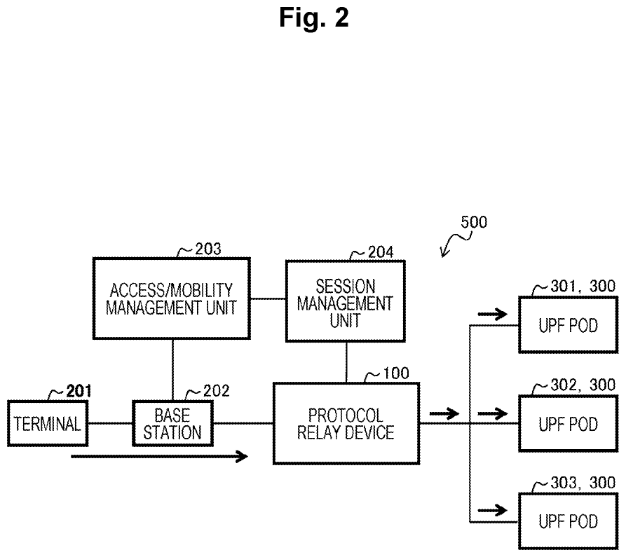

FIG. 2 is a block diagram illustrating an overall configuration of a protocol relay system for explaining a concealment scheme from a base station.

As illustrated in FIG. 2, the protocol relay device 100 receives U-plane communication from the terminal 201 or the base station 202. The protocol relay device 100 transmits a C-plane traffic to the corresponding UPF pods 301 to 303 based on the C-plane adjustment result.

### Outline of Protocol Relay Device

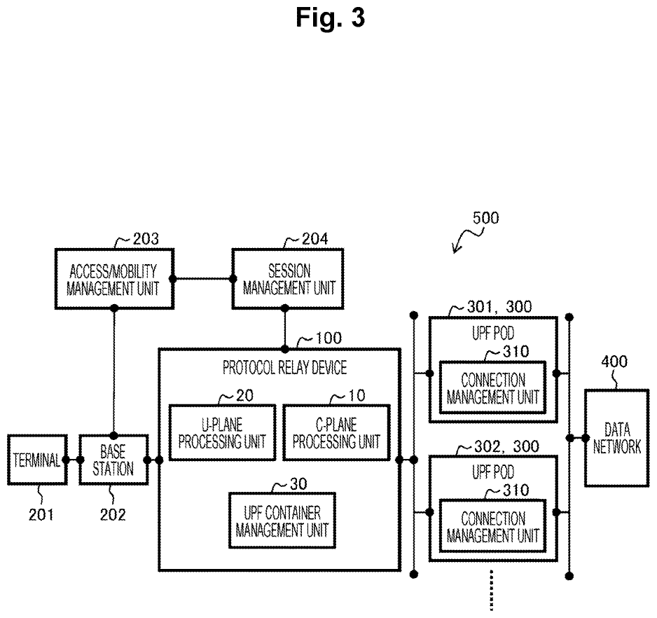

FIG. 3 is a block diagram illustrating configurations of the protocol relay device and the UPF pods in the protocol relay system according to the present embodiment.

As illustrated in FIG. 3, the protocol relay device 100 includes a C-plane processing unit 10 (a control plane processing unit), a U-plane processing unit 20 (a user plane processing unit), and a UPF container management unit 30.

The C-plane processing unit 10 temporarily stores an RFCP request packet from the session management unit 204 in a buffer. In a case where the RFCP request packet is received, the C-plane processing unit 10 determines a UPF for performing transmission processing of a PDU session designated in the request packet. The C-plane processing unit 10 generates an RFCP packet to be exchanged from and to the UPF pods 301 and 302, and notifies the UPF pods 301 and 302 of information on the PDU session for transmission processing by using a modified RFCP packet. In this manner, the C-plane processing unit 10 notifies the UPF pods 301 and 302 of the adjustment result (determination result) for transmission processing.

The U-plane processing unit 20 identifies a session ID of the U-plane traffic received from the base station 202, executes network address translation on the U-plane traffic based on the adjustment result, and transmits the U-plane traffic to the corresponding UPF pods 301 and 302.

The UPF container management unit 30 receives a connection request from one or two or more UPF pods 301 and 302, stores an IP address corresponding to an interface of a connection request source, and notifies the UPF pod 301 or 302 of connection establishment. Further, in a case where a disconnection request is received from the UPF pod 301 or 302, the UPF container management unit 30 deletes an IP address corresponding to the UPF pod 301 or 302 that is a disconnection request source, and deletes setting for translating the network address into an IP address of the UPF pod 301 or 302 that is a disconnection request source. In this manner, the UPF container management unit 30 can perform communication with a connection management unit 310 of the UPF pod 300, and recognize the configuration of the UPF container.

### Configuration of UPF Pod

Each of the UPF pods 301 and 302 includes a connection management unit 310. The connection management unit 310 notifies the protocol relay device 100 of a connection request, and establishes a connection. The connection management unit 310 performs communication with the UPF container management unit 30 of the protocol relay device 100, and notifies the protocol relay device 100 of the configuration of the UPF pod 300.

### Initial State

As illustrated in FIG. 3, as an example, the protocol relay system 500 includes two UPF pods 301 and 302. The two UPF pods 301 and 302 are included in a UPF container.

The protocol relay device 100 includes an interface (gNB opposing interface) of the protocol relay device 100 that is opposing to the base station 202, an interface (SMF opposing interface) of the protocol relay device 100 that is opposing to the session management unit 204, and an interface (UPF opposing interface) of the protocol relay device 100 that is opposing to the UPF pods 300.

The UPF pod 301 or 302 includes an interface (gNB opposing interface) of each UPF pod 300 that is opposing to the base station 202 and an interface (SMF opposing interface) of each UPF pod 300 that is opposing to the session management unit 204.

### Concealment Processing of UPF Pod

In the protocol relay system 500 according to the present embodiment, the protocol relay device 100 executes processing of concealing the UPF pod 300.

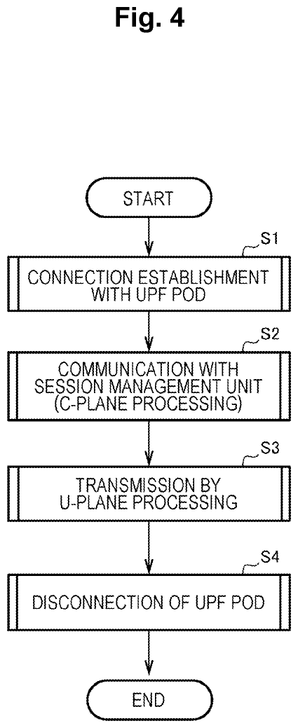

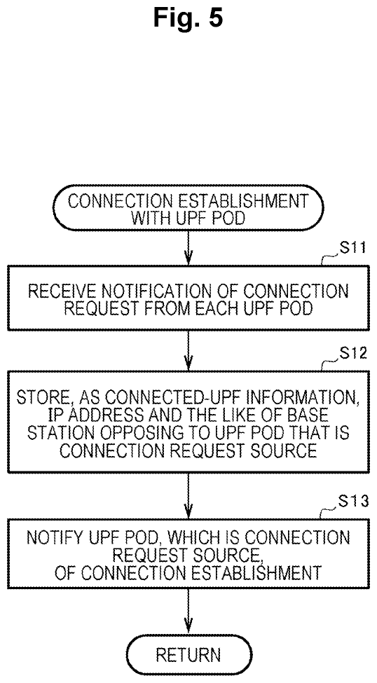

FIG. 4 to FIG. 8 are flowcharts illustrating a flow in a case where the protocol relay device of the protocol relay system executes concealment processing of the UPF pod. FIG. 4 illustrates a flowchart illustrating an overall flow in a case where the protocol relay device 100 executes concealment processing of the UPF pod, and FIG. 5 to FIG. 8 illustrate flowcharts illustrating a detailed flow in each step.

First, in FIG. 4, the protocol relay device 100 establishes a connection with the UPF pod 300 (step S1).

Specifically, in the protocol relay device 100, the UPF container management unit 30 receives a connection request from the UPF pod 300, stores the IP address according to the interface of the connection request source, and notifies the UPF pod 300 of connection establishment. Note that detailed processing in step S1 will be described later with reference to FIG. 5.

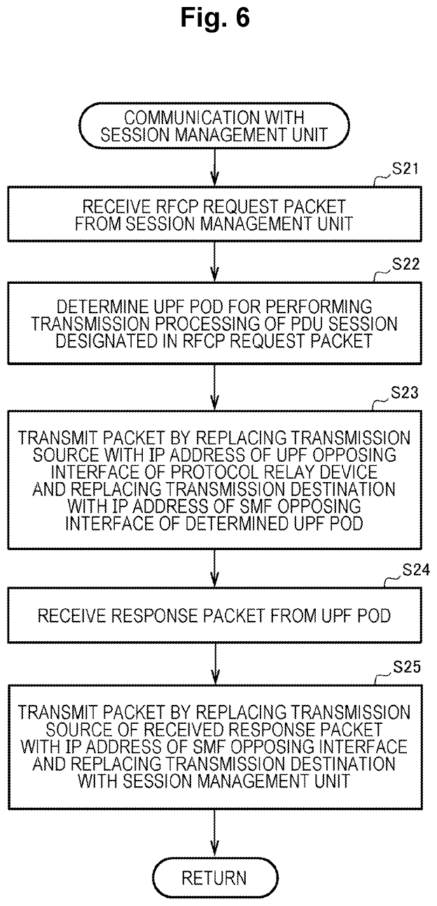

Next, the protocol relay device 100 performs communication with the session management unit 204 (step S2). Specifically, in the protocol relay device 100, in a case where an RFCP request packet is received, the C-plane processing unit 10 determines a UPF pod 300 for performing transmission processing of a PDU session designated in the request packet, and notifies the UPF pod 300 of a determination result. Note that detailed processing in step S2 will be described later with reference to FIG. 6.

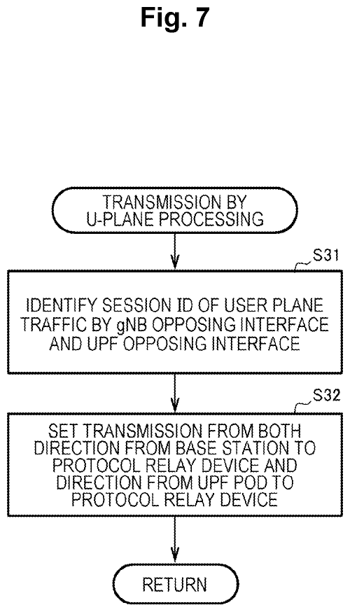

In addition, the protocol relay device 100 performs transmission by U-plane processing (step S3). Specifically, in the protocol relay device 100, the U-plane processing unit 20 identifies a session ID of the U-plane traffic received from the base station 202, executes network address translation on the U-plane traffic based on the determination result, and transmits the U-plane traffic to the corresponding UPF pod 300. Note that detailed processing in step S3 will be described later with reference to FIG. 7.

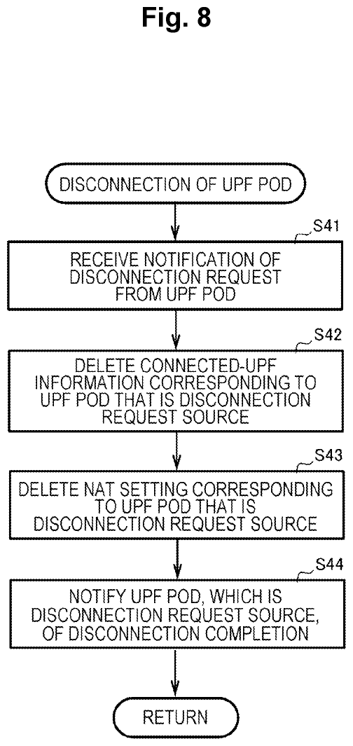

In addition, the protocol relay device 100 executes disconnection of the UPF pod 300 (step S4). Specifically, in the protocol relay device 100, in a case where a disconnection request is received from the UPF pod 300, the UPF container management unit 30 deletes an IP address corresponding to the UPF pod 300 that is a disconnection request source, and deletes setting for translating the network address into an IP address of the UPF pod 300 that is a disconnection request source. Note that detailed processing in step S4 will be described later with reference to FIG. 8.

In the protocol relay device 100, when the UPF container management unit 30 deletes setting for translating the network address into an IP address of the UPF pod 300 that is a disconnection request source, the concealment processing of the UPF pod 300 is ended.

As described above, the protocol relay device 100 of the protocol relay system 500 can conceal the UPF pod 300 from the base station 202 and the session management unit 204. Therefore, even in a case where the configuration of the UPF pod 300 is changed, the containerized UPF pod 300 can be flexibly operated without affecting the opposing device.

In particular, the UPF container management unit 30 of the protocol relay device 100 can disconnect the UPF pod 300 stopped due to scale-in or the like. Therefore, flexible operation can be achieved according to the configuration of the UPF pod 300.

Next, processing of executing connection establishment with the UPF pod 300 in step S1 illustrated in FIG. 4 will be described in detail with reference to the flowchart in FIG. 5.

### Connection Establishment with UPF Pod

Each UPF pod 300 notifies the UPF container management unit 30 of the protocol relay device 100 of the connection request from the connection management unit 310. Thereby, in the protocol relay device 100, the UPF container management unit 30 receives the connection request from each UPF pod 300 (step S11). The connection request includes the IP address of the interface opposing to the base station 202 and the IP address of the interface opposing to the session management unit 204, the interfaces being included in the UPF pod 300 that is a connection request source.

The UPF container management unit 30 stores, as connected-UPF information, the received IP address of the interface opposing to the base station 202 and the received IP address of the interface opposing to the session management unit 204, the interfaces being included in the UPF pod 300 that is a connection request source (step S12).

After storing the connected-UPF information, in the protocol relay device 100, the UPF container management unit 30 notifies the connection management unit 310 of the UPF pod 300, which is a connection request source, of connection establishment (step S13).

In this case, the connection management unit 310 of the UPF pod 300 establishes the connection with the protocol relay device 100, sets the opposing device as the protocol relay device 100, and sets processing during GTP-U transmission to an enabled state. Note that the GTP-U transmission processing itself is assumed to be equivalent to, for example, free5gc as a known technique.

When the connection management unit 310 of the UPF pod 300 that is a connection request source is notified of connection establishment in step S13, the protocol relay device 100 proceeds to step S2 in FIG. 4.

Next, communication processing with the session management unit 204 in step S2 illustrated in FIG. 4 will be described in detail with reference to the flowchart in FIG. 6.

### Communication with Session Management Unit

In the protocol relay device 100, the C-plane processing unit 10 receives an RFCP request packet from the session management unit 204 (step S21). The protocol relay device 100 stores the received request packet in the buffer of the C-plane processing unit 10.

Next, in the protocol relay device 100, the C-plane processing unit 10 determines a UPF pod 300 for performing transmission processing of a PDU session designated in the RFCP request packet (step S22). In this case, for example, two types of determination logic are exemplified below, and the protocol relay device 100 stores a determination result (adjustment result) in the C-plane processing unit 10 while the PDU session continues to exist.

The first determination logic is a method of allocating the processing to all the UPF pods. The second determination logic is a method of allocating the processing to a specific UPF pod.

In a case of allocating the processing to all the UPF pods, the C-plane processing unit 10 of the protocol relay device 100 determines all the UPF pods 300 as transmission devices of the U-plane traffic with a PDU session ID. Thereby, the protocol relay device 100 can distribute a load of the U-plane traffic with a PDU session ID by round robin or the like.

Specifically, for example, the C-plane processing unit 10 allocates all the UPF pods 301, 302, . . . to the transmission destination for each predetermined PDU session ID.

On the other hand, in a case of allocating the processing to a specific UPF pod, as an example, logic such as a hash for selecting a specific UPF pod 300 within a range of options of the UPF pods 300 in a connected state by using, as a key, a PDU session ID for specifying the PDU session is prepared, and a UPF pod 300 that corresponds to the PDU session ID and is a transmission destination is determined. Thereby, when receiving the U-plane traffic, the protocol relay device 100 can transmit the U-plane traffic to the specific UPF pod 300 in units of PDU session ID.

Specifically, the C-plane processing unit 10 allocates the UPF pod 301 as the UPF container of the transmission destination to a certain specific PDU session ID, and allocates the UPF pod 302 as the UPF container of the transmission destination to another specific PDU session ID.

Next, in the protocol relay device 100, the C-plane processing unit 10 transmits the packet by replacing the transmission source of the packet with the IP address of the UPF opposing interface of the protocol relay device 100 and replacing the transmission destination with the IP address of the SMF opposing interface of the UPF pod 300 that is the determined transmission destination (step S23). Note that, in step S22, in a case where the processing is allocated to all the UPF pods 300, the plurality of UPF pods 300 are notified of allocation. Therefore, in this case, the C-plane processing unit 10 generates a plurality of packets for each UPF pod 300 that is the transmission destination, and transmits the packets to the UPF pods 300.

Next, the C-plane processing unit 10 receives a response packet from the UPF pod 300 (step S24).

In addition, in the protocol relay device 100, the C-plane processing unit 10 replaces the transmission source of the received response packet with the IP address of the SMF opposing interface of the protocol relay device 100, replaces the transmission destination of the received response packet with the session management unit 204, and transmits the packet (step S25). In this case, in the protocol relay device 100, the C-plane processing unit 10 deletes the PFCP request packet stored in the buffer in step S21.

When the PFCP request packet stored in the buffer is deleted in step S25, the protocol relay device 100 proceeds to step S3 in FIG. 4.

Next, the transmission processing by the U-plane processing in step S3 illustrated in FIG. 4 will be described in detail with reference to the flowchart in FIG. 7.

### Transmission by U-Plane Processing

In the protocol relay device 100, when receiving the U-plane traffic through the gNB opposing interface of the protocol relay device 100 and the UPF opposing interface of the protocol relay device 100, the U-plane processing unit 20 identifies a PDU session ID (step S31).

In the protocol relay device 100, the U-plane processing unit 20 sets transmission of the U-plane traffic from both a direction from the base station 202 to the protocol relay device 100 and a direction from the UPF pod 300 to the protocol relay device 100 (step S32).

In this case, in the protocol relay device 100, the U-plane processing unit 20 sets network address translation using the IP address of the gNB opposing interface of the protocol relay device 100 and the IP address of the gNB opposing interface of the UPF pod 300 that is the transmission destination of the U-plane traffic with the PDU session ID by referring to the information of the UPF pod 300 (that is, the adjustment result, also referred to as transmission destination UPF pod information) that is the transmission destination of the U-plane traffic with the PDU session ID and is determined by the C-plane processing unit 10.

Note that, in step S22 of FIG. 6, in a case where the processing is allocated to all the UPF pods, since the transmission destination is all the UPF pods 300, the network address is translated to the IP address of the gNB opposing interface of the UPF pod 300 that is the transmission destination by load distribution logic such as round robin or the like.

Further, in the protocol relay device 100, in a case where the U-plane processing unit 20 receives a return U-plane traffic from the UPF pod 300, the U-plane processing unit 20 sets network address translation by the IP address of the gNB opposing interface of the UPF pod 300 that is a transmission source and the IP address of the gNB opposing interface of the protocol relay device 100.

In step S32, in a case where bidirectional transmission of the U-plane traffic is set, the protocol relay device 100 proceeds to step S4 in FIG. 4.

Next, processing of disconnecting the UPF pod 300 in step S4 illustrated in FIG. 4 will be described in detail with reference to the flowchart in FIG. 8.

### Disconnection of UPF Pod

The UPF pod 300 may be stopped in response to scaling-in of the UPF pod 300. Each UPF pod 300 to be stopped notifies the UPF container management unit 30 of the protocol relay device 100 of a disconnection request from the connection management unit 310. Thereby, in the protocol relay device 100, the UPF container management unit 30 receives the notification of the disconnection request from the UPF pod 300 (step S41).

The UPF container management unit 30 of the protocol relay device 100 deletes the connected-UPF information corresponding to the UPF pod 300 that is a disconnection request source (step S42).

In addition, the UPF container management unit 30 deletes the network address translation setting that is set by the U-plane processing unit 20 and corresponds to the UPF pod 300 which is a disconnection request source (step S43). Thereby, the protocol relay device 100 can stop transmission to the UPF pod 300 that is deleted in step S42 in the protocol relay system 500.

The UPF container management unit 30 of the protocol relay device 100 notifies the connection management unit 310 of the UPF pod 300 that is a disconnection request source of disconnection completion (step S44). Thereby, in a case where the notification of the disconnection completion is received from the UPF container management unit 30, the connection management unit 310 of the UPF pod 300 determines that the connection with the protocol relay device 100 is disconnected (disconnection establishment state), and sets the GTP-U transmission processing to the opposing device (the protocol relay device 100) to a disabled state.

In a case where the connection management unit 310 of the UPF pod 300 is notified of the disconnection completion (step S44), the protocol relay device 100 ends the concealment processing of the UPF pod 300.

### Hardware Configuration of Protocol Relay Device

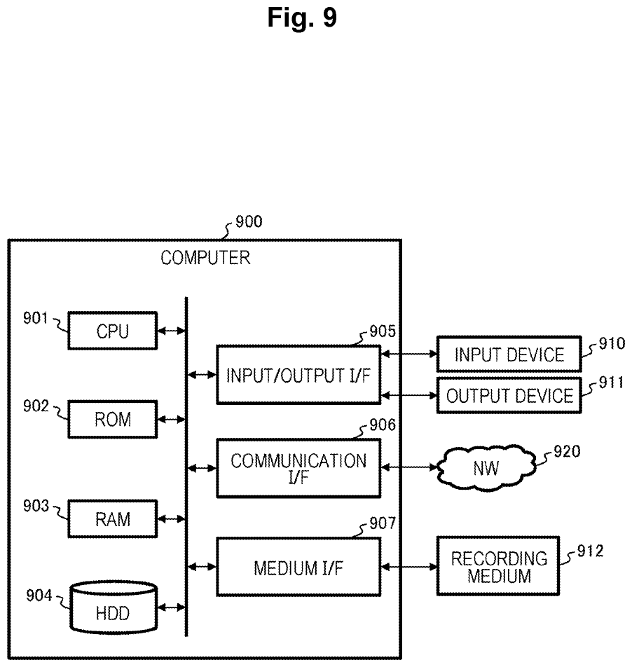

The protocol relay device 100 according to the present embodiment is implemented by, for example, a computer 900 having a configuration as illustrated in FIG. 9.

FIG. 9 is a hardware configuration diagram illustrating an example of a computer that implements functions of the protocol relay device. The computer 900 includes a central processing unit (CPU) 901, a read only memory (ROM) 902, a RAM 903, a hard disk drive (HDD) 904, an input/output interface (I/F) 905, a communication I/F 906, and a medium I/F 907.

In a case where the CPU 901 operates based on a program (a protocol relay program) stored in the ROM 902 or the HDD 904, the C-plane processing unit 10, the U-plane processing unit 20, and the UPF container management unit 30 are implemented. The ROM 902 stores a boot program to be executed by the CPU 901 when the computer 900 is started, a program related to hardware of the computer 900, and the like.

The CPU 901 controls an input device 910 such as a mouse or a keyboard and an output device 911 such as a display or a printer via the input/output I/F 905. The CPU 901 acquires data from the input device 910 and outputs generated data to the output device 911 via the input/output I/F 905. Note that a graphics processing unit (GPU) or the like may be used as a processor together with the CPU 901.

The HDD 904 stores a program to be executed by the CPU 901, data to be used by the program, and the like. The communication I/F 906 receives data from another device via a communication network (for example, network (NW) 920), outputs the data to the CPU 901, and transmits data generated by the CPU 901 to another device via the communication network.

The medium I/F 907 reads a program (for example, a protocol relay program) or data stored in a recording medium 912, and outputs the read program or data to the CPU 901 via the RAM 903. The CPU 901 loads a program related to target processing from the recording medium 912 onto the RAM 903 via the medium I/F 907, and executes the loaded program. The recording medium 912 is an optical recording medium such as a digital versatile disc (DVD) or a phase change rewritable disk (PD), a magneto-optical recording medium such as a magneto optical disk (MO), a magnetic recording medium, a semiconductor memory, or the like.

For example, in a case where the computer 900 functions as the protocol relay device 100 of the present invention, the CPU 901 of the computer 900 implements each function of the protocol relay device 100 by executing the program loaded on the RAM 903. Further, the HDD 904 stores data in the RAM 903. The CPU 901 reads a program related to target processing from the recording medium 912, and executes the program. Additionally, the CPU 901 may read a program related to target processing from another device via the communication network (NW 920).

### Effects

Hereinafter, effects of the processing of concealing the UPF pod 300 in the protocol relay system 500 according to the present invention will be described.

According to the present invention, there is provided a protocol relay device 100 connected to one or two or more UPF pods 300. The protocol relay device includes: a UPF container management unit 30 that receives a connection request from the UPF pod 300, stores an IP address according to an interface of a connection request source, and notifies the UPF pod 300 of connection establishment; a C-plane processing unit 10 that determines, in a case where an RFCP request packet is received, a UPF pod 300 for performing transmission processing of a PDU session which is designated in the request packet, and notifies the UPF pod 300 of a determination result; and a U-plane processing unit 20 that identifies a session ID of user plane traffic received from a base station 202, executes network address translation on the user plane traffic based on the determination result, and transmits the user plane traffic to the corresponding UPF pod 300.

According to the protocol relay device 100 of the present invention, the UPF container management unit 30 receives a connection request from the UPF pod 300, and establishes a connection with the UPF pod 300. The C-plane processing unit 10 receives an RFCP request packet, and determines a UPF pod 300 for performing transmission processing of a PDU session. In addition, the C-plane processing unit 10 notifies the UPF pod 300 of the determination result for the transmission processing. In a case where user plane traffic is received from the base station 202, the U-plane processing unit 20 identifies a session ID of the user plane traffic, executes network address translation on the user plane traffic based on the determination result for the transmission processing, and transmits the user plane traffic to the corresponding UPF pod 300.

Thereby, the protocol relay device 100 can conceal the configuration of the UPF pod 300 included in the container from the base station 202 and the session management unit 204. Therefore, the protocol relay device 100 can flexibly operate the containerized UPF pod 300.

Further, in the protocol relay device 100 according to the present invention, in a case where a disconnection request is received from the UPF pod 300, the UPF container management unit 30 deletes an IP address corresponding to the UPF pod 300 that is a disconnection request source, and deletes setting for translating the network address into an IP address of the UPF pod 300 that is a disconnection request source.

According to the protocol relay device 100 of the present invention, in a case where a disconnection request is received from the UPF pod 300, the UPF container management unit 30 deletes an IP address corresponding to the UPF pod 300 that is a disconnection request source, and deletes setting for translating the network address into an IP address of the UPF pod 300.

Thereby, the protocol relay device 100 can determine a UPF pod 300 to be used when the C-plane processing unit 10 executes the transmission processing, according to the configuration of the UPF pod 300. Thus, the UPF pod 300 can be flexibly operated.

According to the present invention, there is provided a protocol relay system 500. The protocol relay system includes one or two or more UPF pods 300 and a protocol relay device 100 connected to the UPF pods 300. The UPF pod 300 includes a connection management unit 310 that notifies the protocol relay device 100 of a connection request and establishes a connection. The protocol relay device 100 includes: a UPF container management unit 30 that receives a connection request from the UPF pod 300, stores an IP address according to an interface of a connection request source, and notifies the UPF pod 300 of connection establishment; a C-plane processing unit 10 that determines, in a case where an RFCP request packet is received, a UPF pod 300 for performing transmission processing of a PDU session designated in the request packet, and notifies the UPF pod 300 of a determination result; and a U-plane processing unit 20 that identifies a session ID of user plane traffic received from the base station 202, executes network address translation on the user plane traffic based on the determination result, and transmits the user plane traffic to the corresponding UPF pod 300.

According to the protocol relay system 500 of the present invention, the UPF container management unit 30 of the protocol relay device 100 receives a connection request from the UPF pod 300, and establishes a connection with the UPF pod 300. The C-plane processing unit 10 receives an RFCP request packet, and determines a UPF pod 300 for performing transmission processing of a PDU session. In addition, the C-plane processing unit 10 notifies the UPF pod 300 of the determination result. In a case where user plane traffic is received from the base station 202, the U-plane processing unit 20 identifies a session ID of the user plane traffic, executes network address translation on the user plane traffic based on the determination result, and transmits the user plane traffic to the corresponding UPF pod 300.

Thereby, the protocol relay system 500 can conceal the configuration of the UPF pod 300 included in the container from the base station 202 and the session management unit 204. Therefore, the protocol relay system 500 can flexibly operate the containerized UPF pod 300.

Further, in the protocol relay system 500 according to the present invention, in a case where a disconnection request is received from the UPF pod 300, the UPF container management unit 30 of the protocol relay device 100 deletes an IP address corresponding to the UPF pod 300 that is a disconnection request source, and deletes setting for translating the network address into an IP address of the UPF pod 300 that is a disconnection request source.

According to the protocol relay system 500 of the present invention, in a case where a disconnection request is received from the UPF pod 300, the UPF container management unit 30 deletes an IP address corresponding to the UPF pod 300 that is a disconnection request source, and deletes setting for translating the network address into an IP address of the UPF pod 300.

Thereby, the protocol relay system 500 can determine a UPF pod 300 to be used when the C-plane processing unit 10 executes the transmission processing, according to the configuration of the UPF pod 300. Thus, the UPF pod 300 can be flexibly operated.

Note that the present invention is not limited to the above-described embodiment, and many modifications can be made by those skilled in the art within the technical idea of the present invention.

### REFERENCE SIGNS LIST

10 C-plane processing unit (control plane processing unit)
20 U-plane processing unit (user plane processing unit)
30 UPF container management unit
100 Protocol relay device
100P Relay device
201 Terminal
202 Base station
203 Access/mobility management unit
204 Session management unit
205 Network function exposure management unit
206 Network function registration management unit
207 Policy control unit
208 Unified-data management unit
209 Authentication server management unit
300 to 303, 301P to 306P UPF pod
310 Connection management unit
400 Data network
500 Protocol relay system
500P System architecture

1. A protocol relay device connected to one or two or more user plane functions (UPFs), the protocol relay device comprising:
a UPF container management unit, including one or more processors, configured to receive a connection request from the UPF, stores an internet protocol (IP) address according to an interface of a connection request source, and notify the UPF of connection establishment;
a control plane processing unit, including one or more processors, configured to determine, in a case where a packet-transmission-control-protocol request packet is received, a UPF for performing transmission processing of a protocol data unit (PDU) session which is designated in the request packet, and notify the UPF of a determination result; and
a user plane processing unit, including one or more processors, configured to identify a session identification (ID) of user plane traffic received from a base station, executes network address translation on the user plane traffic based on the determination result, and transmit the user plane traffic to the corresponding UPF.

2. The protocol relay device according to claim 1, wherein,
in a case where a disconnection request is received from the UPF, the UPF container management unit is configured to delete an IP address corresponding to the UPF that is a disconnection request source, and delete setting for translating a network address into an IP address of the UPF that is a disconnection request source.

3. A protocol relay system comprising:
one or two or more UPFs; and
a protocol relay device connected to the UPFs, wherein
the UPF includes
a connection management unit, including one or more processors, configured to notify the protocol relay device of a connection request and establishes a connection, and
the protocol relay device includes
a UPF container management unit, including one or more processors, configured to receive the connection request from the UPF, stores an IP address according to an interface of a connection request source, and notify the UPF of connection establishment,
a control plane processing unit, including one or more processors, configured to determine, in a case where a packet-transmission-control-protocol request packet is received, a UPF for performing transmission processing of a PDU session which is designated in the request packet, and notify the UPF of a determination result, and
a user plane processing unit, including one or more processors, configured to identify a session ID of user plane traffic received from a base station, execute network address translation on the user plane traffic based on the determination result, and transmit the user plane traffic to the corresponding UPF.

4. The protocol relay system according to claim 3, wherein
in a case where a disconnection request is received from the UPF, the UPF container management unit is configured to delete an IP address corresponding to the UPF that is a disconnection request source, and delete setting for translating a network address into an IP address of the UPF that is a disconnection request source.

5. A protocol relay method performed by a protocol relay device connected to one or two or more UPFs, the method comprising:
receiving a connection request from the UPF, and storing an IP address according to an interface of a connection request source;
notifying the UPF of connection establishment;
determining, in a case where a packet-transmission-control-protocol request packet is received, a UPF for performing transmission processing of a PDU session which is designated in the request packet, and notifying the UPF of a determination result; and
identifying a session ID of user plane traffic received from a base station, executing network address translation on the user plane traffic based on the determination result, and transmitting the user plane traffic to the corresponding UPF.

6. The protocol relay method according to claim 5, further comprising:
deleting, in a case where a disconnection request is received from the UPF, an IP address corresponding to the UPF that is a disconnection request source, and deleting setting for translating a network address into an IP address of the UPF that is the disconnection request source.

7. A non-transitory computer-readable storage medium storing protocol relay program causing a computer to execute operations of the protocol relay method according to claim 5.

8. (canceled)
